(19) United States
(12) Patent Application Publication
(10) Pub. No.: US 2007/0286447 A1
(43) Pub. Date: Dec. 13, 2007

(54) Speaker device

(75) Inventors: Hiroyuki Tomiyama, Yamagata (JP); Koji Maekawa, Yamagata (JP); Hiroyuki Dohi, Yamagata (JP)

Correspondence Address: NIXON & VANDERHYE, PC, 901 NORTH GLEBE ROAD, 11TH FLOOR, ARLINGTON, VA, 22203, US

(73) Assignees: PIONEER CORPORATION, Tokyo (JP); TOHOKU PIONEER CORPORATION, Yamagata (JP)

(21) Appl. No.: 11/785,738

(22) Filed: Apr. 19, 2007

(30) Foreign Application Priority Data
Apr. 19, 2006 (JP) 2006-115355

(51) Int. Cl. H04R 11/02

(52) U.S. Cl. 381/400

(57) ABSTRACT

A ribbon-shaped speaker device includes a magnetic circuit which has two magnetic gaps; two diaphragms which have conductive properties and which are arranged substantially in parallel with and opposite to each other in each of the magnetic gaps; and a driving part which supplies a driving current to each of the diaphragms. A direction of a magnetic flux in each of the magnetic gaps and a direction of the driving current supplied to each of the diaphragms are set such that each of the diaphragms moves in a same direction. Each of the diaphragms inclines in a direction adjacent to each other.

### BACKGROUND OF THE INVENTION

1. Field of the Invention

The present invention relates to improvement of a sound pressure characteristic of a ribbon-shaped speaker device.

2. Description of Related Art

Conventionally, as a speaker device for extra high-frequency-band reproduction, there is known a ribbon-shaped speaker device enabling sound reproduction up to an extra high frequency band of substantially 100 KHz.

The ribbon-shaped speaker device mainly includes a magnetic circuit including a yoke, a pair of magnets arranged opposite to each other on the yoke and a pair of plates arranged at a position corresponding to each of the pair of magnets, and a ribbon-shaped diaphragm made of a conductive material. In this ribbon-shaped speaker device, a magnetic gap is formed between the pair of plates, and a ribbon-shaped diaphragm is arranged in the magnetic gap. In addition, both end parts of the ribbon-shaped diaphragm are connected to a secondary transformer of a matching transformer (impedance conversion transformer) via each of plus and minus lead wires, and a primary transformer of the matching transformer is connected to a driving power source.

In the ribbon-shaped speaker device having the above-mentioned configuration, the impedance conversion is performed so that a driving current supplied from the driving power source becomes a predetermined driving current by the matching transformer, and the predetermined driving current is supplied to the ribbon-shaped diaphragm. Thereby, in accordance with Fleming's left-hand rule, the ribbon-shaped diaphragm vibrates, and the sound reproduction in the extra high-frequency-band is performed.

The ribbon-shaped speaker device having the configuration of this kind is disclosed in Japanese Patent Application Laid-open under No. 10-178699 (Reference-1) and Japanese Utility Model 3023579 (Reference-2), for example.

In the ribbon-shaped speaker device according to Reference-1, the ribbon-shaped diaphragm is arranged in a magnetic gap formed between a pair of pole pieces in parallel with an upper surface of a magnetic yoke. Additionally, in the ribbon-shaped electric acoustic conversion device according to Reference-2, the magnetic gap is formed between the pair of magnets. At the same time, the ribbon-shaped diaphragm is arranged in the magnetic gap, and a conductive board is arranged to surround the ribbon-shaped diaphragm. The ribbon-shaped diaphragm is arranged to substantially become flush with the conductive board.

There is known a leaf-shaped speaker device including an equalizer (phase equalizer) having a function to equalize the high-frequency-band characteristic (see Japanese Patent Application Laid-open under No. 2003-169393 (Reference-3)). In this leaf-shaped speaker device, the magnetic circuit is mounted on a frame having a U-shaped cross-section. The magnetic circuit includes an outer yoke having a U-shaped cross-section, a magnet arranged at the center of the outer yoke and a plate arranged on the magnet. The diaphragm is arranged so that a pattern coil is mounted on an upper surface of a magnetic gap, and the equalizer having a triangle cross-section is mounted on a frame of the diaphragm. A top part of the equalizer is positioned above the upper end of the frame.

However, in the above Reference-1, the ribbon-shaped diaphragm is arranged in the magnetic gap formed between the pair of pole pieces in parallel with the upper surface of the magnetic yoke. Additionally, in the above Reference-2, the ribbon-shaped diaphragm is arranged to substantially become flush with the conductive board in the magnetic gap. Therefore, it is problematic that the mechanical impedance of the ribbon-shaped diaphragm structurally becomes unequal at the time of the high-frequency-band reproduction and the ribbon-shaped diaphragm is deformed. In the above References-1 and 2, it is also problematic that a directional characteristic in the high-frequency-band deteriorates and no extra high frequency acoustic wave can be outputted in the wide range.

In addition, in the above Reference-3, since the top part of the equalizer is positioned above the upper end of the frame, it is problematically difficult to realize the thin speaker device.

### SUMMARY OF THE INVENTION

The present invention has been achieved in order to solve the above problem. It is an object of this invention to provide a ribbon-shaped speaker device capable of preventing deformation of a diaphragm and improving a directional characteristic and a sound pressure characteristic.

According to one aspect of the present invention, there is provided a speaker device, being a so-called ribbon-shaped speaker device, including: a magnetic circuit which has at least two magnetic gaps; at least two diaphragms which have conductive properties and which are arranged substantially in parallel with and opposite to each other in each of the magnetic gaps; and a driving part which supplies a driving current to each of the diaphragms, wherein a direction of a magnetic flux in each of the magnetic gaps and a direction of the driving current supplied to each of the diaphragms are set such that each of the diaphragms moves in a same direction, and wherein each of the diaphragms inclines in a direction adjacent to each other.

The above speaker device includes the magnetic circuit which has at least two magnetic gaps, at least two diaphragms which have the conductive properties and which are arranged substantially in parallel with and opposite to each other in each of the magnetic gaps and the driving part which supplies the driving current to each of the diaphragms. In addition, the direction of the magnetic flux in each of the magnetic gaps and the direction of the driving current supplied to each of the diaphragms is set such that each of the diaphragms moves in the same direction. In a preferred example, when the direction of the magnetic flux in each of the magnetic gaps is relatively opposite, it is preferable that the direction of the driving current supplied to each of the diaphragms is relatively opposite to each of the diaphragms.

Particularly, since each of the diaphragms inclines in the direction adjacent to each other, operation and effect which will be explained below can be obtained.

Namely, in the speaker device having such a configuration, before a divisional vibration of each of the diaphragm starts in a low frequency band, each of the diaphragms vibrates in the direction substantially orthogonal with respect to the direction of the magnetic flux in each of the correspondent magnetic gaps. However, since each of the diaphragms inclines in the direction adjacent to each other, a vibration vector of each of the diaphragms is synthesized, and each of the diaphragms vibrates in the direction of the central axis of the speaker device. Thereby, a large number of synthesized acoustic waves of each of the diaphragms are outputted in the direction of the central axis of the speaker device. Meanwhile, in the high frequency band, since the mechanical impedance of both the end parts of each of the diaphragms is larger than that at the middle part of each of the diaphragms, the vibration is small in the vicinity of both the end parts. But the vibration is large at the middle part. Therefore, in the vicinity of the middle part, each of the diaphragms largely vibrates in the direction substantially orthogonal with respect to the direction of the magnetic flux in the correspondent magnetic gap, and the acoustic wave of each of the diaphragms is largely outputted to have the directional characteristic in the vibration direction thereof. In this manner, the vibration vector of each of the diaphragms is synthesized, and a large number of the synthesized acoustic waves are outputted in the direction of the central axis of the speaker device. As a result, the speaker device can structurally output the acoustic wave in the extra high frequency band within the wide range.

In addition, since each of the diaphragms inclines in the direction adjacent to each other, the strength of each of the diaphragms in the direction of the central axis of the speaker device is improved, as compared with a comparative example having such a configuration that neither of the diaphragms inclines. Namely, the strength of each of the diaphragms can be improved. Particularly, in the above low frequency band, since each of the diaphragms after the movement retains an initial shape and vibrates, the strength of each of the diaphragms can be further improved. Additionally, in a case of the high frequency band, each of the diaphragms moves so that the vibration becomes small at both the end parts of each of the diaphragms and the vibration becomes large at the middle part thereof. Thus, each of the diaphragms is hardly deformed by the radiation impedance.

Additionally, in the speaker device, the directional characteristic in the high frequency band can be set to a desired directional characteristic by varying the inclination angle of each of the diaphragms.

In a manner of the above speaker device, the magnetic circuit may include a first magnetic pole provided at a substantially middle position thereof, a second magnetic pole and a third magnetic pole provided on both sides of the first magnetic pole. The first magnetic pole may be positioned below the second magnetic pole and the third magnetic pole. Each of the magnetic gaps may be formed between the first magnetic pole and the second magnetic pole and between the first magnetic pole and the third magnetic pole, and a direction of the magnetic flux in each of the magnetic gaps may be relatively opposite. Each of the diaphragms may be arranged along the direction of the magnetic flux in each of the magnetic gaps.

In this manner, the magnetic circuit includes the first magnetic pole provided at the substantially middle position thereof, the second magnetic pole and the third magnetic pole provided on both the sides of the first magnetic pole. The first magnetic pole is positioned below the second magnetic pole and the third magnetic pole. In a preferred example, the first magnetic pole is formed by a part of the yoke, and the second magnetic pole and the third magnetic pole are formed by a combination of the magnet and the plate, respectively, and an upper end of the part of the yoke is positioned below an upper end of the plate. Each of the magnetic gaps is formed between the first magnetic pole and the second magnetic pole and between the first magnetic pole and the third magnetic pole, and the direction of the magnetic flux in each of the magnetic gaps is relatively opposite. In addition, each of the diaphragms may be arranged along the direction of the magnetic flux in each of the magnetic gaps, respectively. Thereby, the strength of each of the diaphragms can be improved, and the acoustic wave in an extra high frequency band can be outputted in the wide range.

In a manner of the above speaker device, when the magnetic circuit and each of the diaphragms are observed from a direction substantially orthogonal with respect to the direction of the driving current, a shape formed by connecting the magnetic flux between the first magnetic pole and the second magnetic pole and the magnetic flux between the first magnetic pole and the third magnetic pole may be a substantially V shape, and a shape formed by connecting each of the diaphragms maybe a substantially V shape.

In this manner, when the magnetic circuit and each of the diaphragms are observed from the direction substantially orthogonal with respect to the direction of the driving current, the shape formed by connecting the magnetic flux between the first magnetic pole and the second magnetic pole and the magnetic flux between the first magnetic pole and the third magnetic pole is the substantially V shape, and the shape formed by connecting each of the diaphragms is the substantially V shape. Thereby, the strength of each of the diaphragms can be improved, and the acoustic wave in the extra high frequency band can be outputted in the wide range.

In another manner of the above speaker device, each of the diaphragms may have a ribbon and short rectangular shape, and the magnetic circuit may have a rectangular parallelepiped shape. Thereby, the ribbon-shaped speaker device can be formed.

In a preferred example, each of the diaphragms may be made of a metallic foil. Each of the diaphragms may be made of a resin film and a conductive material formed on a surface of the resin film and to which the driving current is supplied. Each of the diaphragms may be formed by folding a metallic foil having a ribbon and short rectangular shape.

In another preferred example, one end side of each of the diaphragms positioned on a side of the first magnetic pole may be connected by a viscoelastic material. Thereby, a low frequency sound can be easily obtained. One end side of each of the diaphragms positioned on a side of the first magnetic pole may be mounted on the first magnetic pole via a viscoelastic material. It is preferable that the viscoelastic material is made of a light material having a viscosity, elasticity and an adhesive property.

In still another preferred example, another end side of each of the diaphragms positioned on a side opposite to the first magnetic pole may have a corrugated cross-section. Additionally, an entire or a part of each of the diaphragms may have a muscle-like corrugation shape or a convexoconcave shape. Further, each of the diaphragms may be mounted on the first magnetic pole via a diaphragm mounting member for supporting each of the diaphragms.

In still another manner of the above speaker device, a phase equalizer having a function to equalize high-frequency-band signal may be provided between the diaphragms positioned on a side of the first magnetic pole and on the first magnetic pole.

In this manner, since the phase equalizer (an equalizer, an acoustic diffuser of magnetic substance or a restrictor for increasing an acoustic load) having the function to equalize the high-frequency-band signal is provided between the diaphragms positioned on the side of the first magnetic pole and on the first magnetic pole, the high-frequency-band signal can be equalized, and the preferred sound pressure characteristic can be obtained in the high frequency band.

In still another manner of the above speaker device, the phase equalizer may have an insulating property and include a projecting part formed into a projecting shape and upwardly projecting between the diaphragms positioned on the side of the first magnetic pole, and each of the diaphragms may be mutually cut off by the projecting part.

In this manner, the phase equalizer has the insulating property and includes the projecting part formed into the projecting shape and upwardly projecting between the diaphragms positioned on the side of the first magnetic pole. Each of the diaphragms is mutually shielded by the projecting part. Thereby, since each of the diaphragms is shielded by the projecting part having the insulating property, the short circuit of each of the diaphragms can be prevented. Additionally, in this manner, since the projecting part is provided to upwardly project between the diaphragms on the first magnetic pole positioned below the second magnetic pole and the third magnetic pole, the projecting amount of projecting part can be reduced in correspondence with the purpose. Thus, the speaker device can be thin. Namely, the thin ribbon-shaped speaker device can be obtained. Further, since the variable range of the height of the projecting part can be large by the configuration, correction for the desired sound pressure characteristic can be performed.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIGS. 1A and 1B are a perspective view and a cross-sectional view showing a configuration of a speaker device according to an embodiment of the present invention;

FIGS. 2A and 2B are cross-sectional views showing a configuration of a speaker device according to various kinds of comparative examples;

FIGS. 3A and 3B are cross-sectional views for explaining operation of a diaphragm according to this embodiment;

FIGS. 4A to 4C are cross-sectional views and a perspective view showing a configuration of a speaker device according to applications-1 to application-3 of the present invention;

FIG. 5 is a cross-sectional view showing a configuration of a speaker device according to an application-4 of the present invention;

FIGS. 6A and 6B show cross-sectional views of a configuration of a diaphragm mounted on a diaphragm mounting member according to an application-5 of the present invention;

FIGS. 7A and 7B are cross-sectional views for explaining operation of the diaphragm according to the application-5;

FIGS. 8A and 8B show cross-sectional views in a connection state between a diaphragm and an impedance conversion transformer according to an application-6 of the present invention;

FIG. 9 shows a cross-sectional view in the connection state between the diaphragm and the impedance conversion transformer according to an application-7 of the present invention;

FIGS. 10A and 10B are a plan view and a cross-sectional view showing the configuration of the diaphragm according to an application-8 of the present invention;

FIGS. 11A to 11F show plan views, a side view and a cross-sectional view showing the configuration of the diaphragm according to an application-9 of the present invention;

FIGS. 12A to 12C show perspective views and the like of the speaker device and a phase equalizer according to an application-10of the present invention; and

FIG. 13 is a cross-sectional view showing the configuration of the speaker device including the phase equalizer according to the comparative example.

### DETAILED DESCRIPTION OF THE PREFERRED EMBODIMENTS

Now, preferred embodiments of the present invention will be described below with reference to the attached drawings.

[Configuration of Speaker Device]

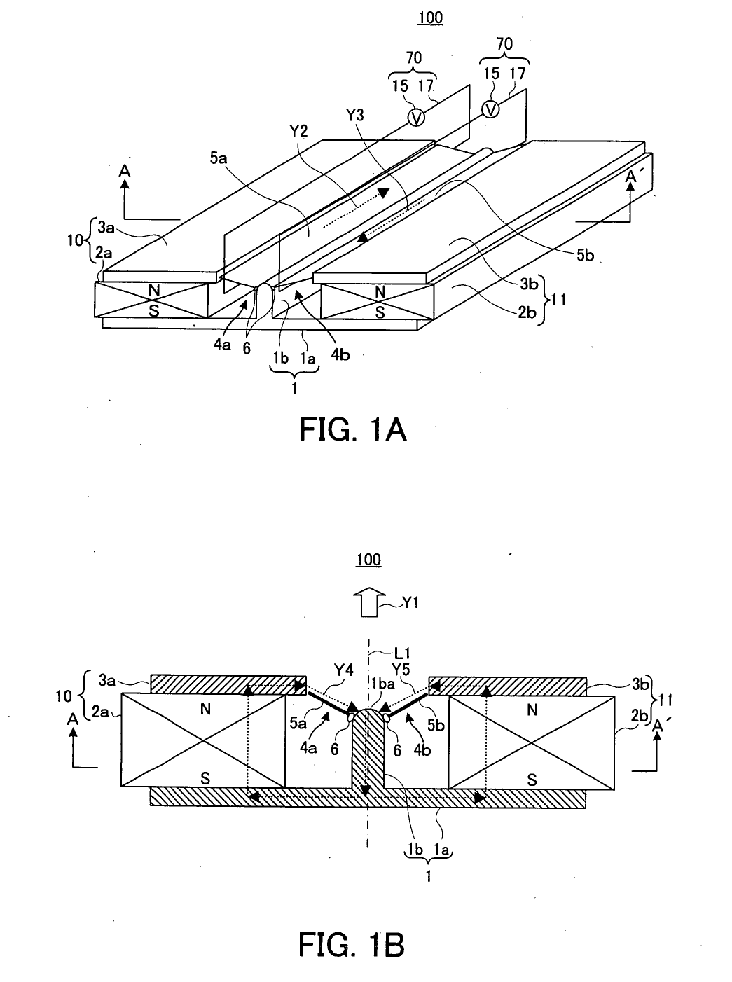

First, a description will be given of a configuration of a speaker device 100 according to an embodiment of the present invention, with reference to FIGS. 1A and 1B.

FIG. 1A shows a perspective view of the speaker device 100 according to the embodiment of the present invention when observed from a sound output side. FIG. 1B shows a cross-sectional view of the speaker device 100 taken along a cutting-line A-A′ shown in FIG. 1A.

The speaker device 100 is a speaker device for extra high-frequency-band reproduction, and includes a rectangular-parallelepiped magnetic circuit including a yoke 1, a pair of magnets 2a and 2b and a pair of plates 3a and 3b, two diaphragms 5a and 5b and a driving part 70 for driving each of the diaphragms 5a and 5b.

The configuration of the magnetic circuit will be explained below.

The yoke 1, having a reversed-T-shaped cross-section, includes a pole part (first magnetic pole) 1b provided at a substantially middle position and a supporting part la for supporting the pair of magnets 2a and 2b, provided on both sides of the pole part 1b. An upper end 1ba of the first magnetic pole 1b, i.e., the upper end 1ba of the pole part, is set to a height positioned below upper surfaces of the pair of plates 3a and 3b. Each of the magnets 2a and 2b, having a rectangular-parallelepiped shape, is mounted on the correspondent supporting part 1a. Positional relations of an N-pole and an S-pole of the pair of magnets 2a and 2b are same. Namely, in this embodiment, the sides of the pair of magnets 2a and 2b, positioned on the supporting part la of the yoke 1, are magnetized to the S-pole, and the other sides of them, positioned on the side of the pair of plates 3a and 3b, are magnetized to the N-pole. But this is only one example. Namely, in the present invention, the positional relations of the N-pole and the S-pole of the pair of magnets 2a and 2b may be reverse to the above-mentioned example. Each of the plates 3a and 3b, having a flat rectangular-parallelepiped shape, is mounted on each of the correspondent magnets 2a and 2b. The magnet 2a and the plate 3a form “a second magnetic pole 10”, and the magnet 2b and the plate 3b form “a third magnetic pole 11”.

In the magnetic circuit having the above configuration, the magnetic field is formed, as shown by a broken line in FIG. 1B. Therefore, the magnetic circuit includes two magnetic gaps. A first magnetic gap 4a is formed between the first magnetic pole 1b and the second magnetic pole 10, and a second magnetic gap 4b is formed between the first magnetic pole 1b and the third magnetic pole 11. The direction of the magnetic flux in the first magnetic gap 4a is set to the direction of an arrow Y4 from the second magnetic pole 10 to the first magnetic pole 1b, and the direction of the magnetic flux in the second magnetic gap 4b is set to the direction of an arrow Y5 from the third magnetic pole 11 to the first magnetic pole 1b. Thus, the direction of the magnetic flux in the first magnetic gap 4a is relatively opposite to the direction of the magnetic flux in the second magnetic gap 4b.

Each of the diaphragms 5a and 5b, having a ribbon and short-rectangular shape, is made of the conductive material having the conductive property, such as the metallic foil. Each end of the diaphragms 5a and 5b arranged on the side of the first magnetic pole 1b is attached to the vicinity of the upper end 1ba of the first magnetic pole 1b with a suitable space therebetween via a viscoelastic material (damp material) 6. The diaphragms 5a and 5b are respectively arranged so that they are substantially in parallel with each other and the shape formed by the combination of them has a substantially V-shaped cross-section. In addition, each of the diaphragms 5a and 5b is arranged along each direction of the arrows Y4 and Y5 being the direction of the magnetic flux in each of the first magnetic gap 4a and the second magnetic gap 4b. Therefore, each of the diaphragms 5a and 5b inclines in the direction adjacent to each other. The viscoelastic material (damp material) is preferably made of a light member having the viscosity, the elasticity and the adhesive property.

Each of the driving parts 70 includes an electric circuit including a wiring 17 connected to both ends of each of the diaphragms 5a and 5b and a power source 15 for supplying the driving current to each of the diaphragms 5a and 5b, connected to the wiring 17. In this embodiment, the directions of the currents flowing in the diaphragms 5a and 5b relatively become opposite by each of the driving parts 70. Namely, in this embodiment, when the direction of the current flowing in the diaphragm 5a is assumed in the direction of the arrow Y2, it is prescribed that the current flows in the direction of the arrow Y3 in the diaphragm 5b. But the present invention is not limited to this configuration. Namely, both ends of each of the diaphragms 5a and 5b may be connected to each of the driving parts 70 via a transformer (not shown) in the present invention.

In the above-mentioned speaker device 100, the driving current outputted from each of the driving parts 70 is outputted to each of the diaphragms 5a and 5b. Thereby, in accordance with Fleming's left-hand rule, the driving force of the same amount and in the same direction is generated on the diaphragm 5a in the first magnetic gap 4a and on the diaphragm 5b in the second magnetic gap 4b, respectively. Thereby, the diaphragms 5a and 5b vibrate in the direction of a central axis L1 of the speaker device 100. In this manner, the speaker device 100 outputs the synthesized acoustic wave in the direction of the arrow Y1 through the diaphragms 5a and 5b.

Next, a description will be given of operation and effect according to this embodiment, as compared with various kinds of comparative examples.

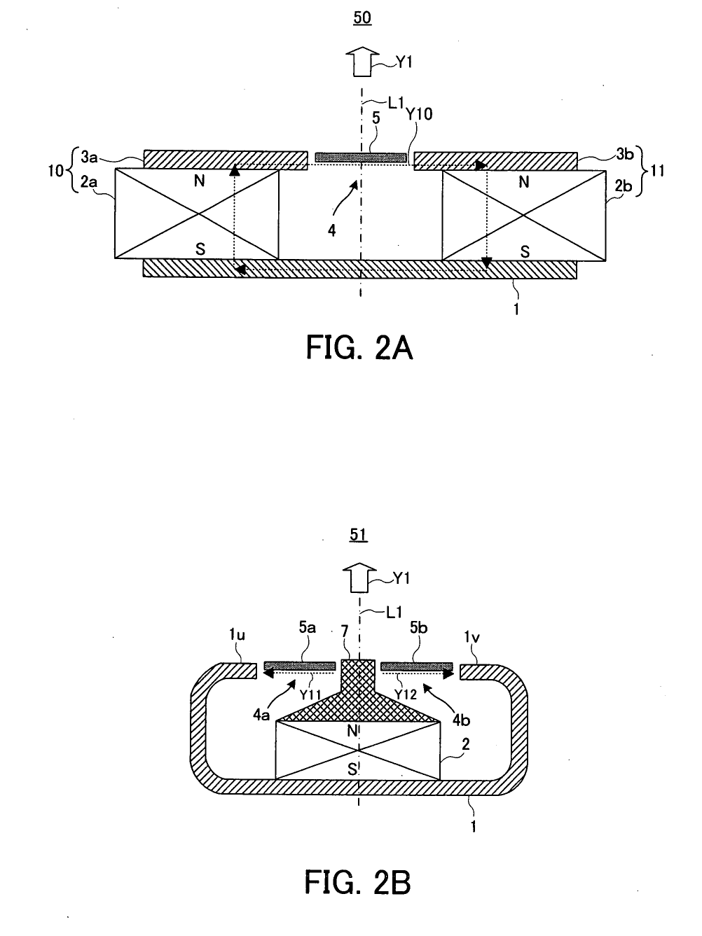

First, a configuration of a first comparative example will be explained with reference to FIG. 2A, and subsequently, a configuration of a second comparative example will be explained with reference to FIG. 2B. In the first and second comparative examples, the same numeral references are given to the same components as those of this embodiment, and explanations thereof are simplified or omitted.

A speaker device 50 according to the first comparative example includes the magnetic circuit including the yoke 1 formed into a flat plate shape, the pair of magnets 2a and 2b mounted on both ends on the yoke 1 and the pair of plates 3a and 3b mounted on the pair of magnets 2a and 2b, the ribbon-shaped diaphragm 5 and the driving part (corresponding to the driving part 70) (not shown). The positional relation of the S-pole and the N-pole of the pair of magnets 2a and 2b is same as that of the embodiment, and the magnetic gap 4 is formed between the first magnetic pole 10 and the second magnetic pole 11. The diaphragm 5 is formed between the pair of plates 3a and 3b, at which the magnetic gap 4 is formed. The diaphragm 5 is connected to the driving part, substantially similarly to the embodiment, and the driving current is supplied to the diaphragm 5. In the first comparative example having the above configuration, the driving current outputted from the driving part is supplied to the diaphragm 5, which outputs the acoustic wave in the direction of the arrow Y1 in accordance with the Fleming's left-hand rule.

On the other hand, a speaker device 51 according to the second comparative example includes the magnetic circuit including the yoke 1 formed into a cylindrical shape and having an opening on its upper surface, the magnet 2 arranged at the central position on the yoke 1 and a plate 7 arranged on the magnet 2 and having a substantially reversed T shape, the ribbon-shaped diaphragm Sa arranged between the upper end part of the plate 7 and one end side 1u of the yoke 1, another ribbon-shaped diaphragm 5b arranged between the upper end of the plate 7 and other end side 1v of the yoke 1, and the driving part (corresponding to the driving part 70) (not shown). The first magnetic gap 4a is formed between the one end side 1u of the yoke 1 and the upper end part of the plate 7, and the second magnetic gap 4b is formed between the other end side 1v of the yoke 1 and the upper end part of the plate 7, respectively. The direction of the magnetic flux in the first magnetic gap 4a is the direction of an arrow Y11, and the direction of the magnetic flux in the second magnetic gap 4b is the direction of an arrow Y12 opposite to the arrow Y11. The pair of diaphragms 5a and 5b are connected to the driving part, similarly to the embodiment, and the driving current is supplied to the pair of diaphragms 5a and 5b. In the second comparative example having the above-mentioned configuration, the driving current outputted from the driving part is supplied to the pair of diaphragms 5a and 5b, and the pair of diaphragms 5a and 5b output the acoustic wave in the direction of the arrow Y1 in accordance with the Fleming's left-hand rule.

In the first comparative example having the above-mentioned configuration, the magnetic flux in the magnetic gap 4 is formed in a straight line, as shown by the arrow Y10. Further, the diaphragm 5 is arranged to have a straight-line cross-section in the extension direction of the magnetic flux in the magnetic gap 4. In addition, in the second comparative example, a shape formed by connecting the magnetic flux in the first magnetic gap 4a and the magnetic flux in the second magnetic gap 4b is formed into a straight line, and the pair of diaphragms 5a and 5b are arranged to have a straight-line cross-section in the first magnetic gaps 4a and 4b. In the first and second comparative examples, since the mechanical impedance of the diaphragm 5 or the pair of diaphragms 5a and 5b becomes ununiform at the time of the high-frequency-band reproduction due to the configuration, the diaphragm 5 or the pair of diaphragms 5a and 5b is problematically deformed. In addition, in the first and second comparative examples, it is problematic that the directional characteristic is structurally deteriorated in the high frequency band and the acoustic wave in the extra high frequency band cannot be outputted in the wide range.

On the other hand, the configuration, which will be described below, is employed in this embodiment. First, in this embodiment, the speaker device 100 includes the magnetic circuit including the first magnetic gap 4a and the second magnetic gap 4b, the diaphragms 5a and 5b having the conductive property and arranged substantially in parallel with and opposite to each other in each of the first magnetic gap 4a and the second magnetic gap 4b, and the driving part 70 for driving each of the diaphragms 5aand5b. The driving current is supplied to each of the diaphragms 5a and 5b from the driving part 70. The direction of the magnetic flux in each of the first magnetic gap 4a and the second magnetic gap 4b and the direction of the driving current supplied to each of the diaphragms 5a and 5b are set to such a direction that each of the diaphragms 5a and 5b moves in the same direction. Each of the diaphragms 5a and 5b inclines in the direction adjacent to each other.

Concretely, in this embodiment, the upper end 1ba of the first magnetic pole 1b is positioned below the upper end of the second magnetic pole 10 and the upper end of the third magnetic pole 11. The first magnetic gap 4a is formed between the first magnetic pole 1b and the second magnetic pole 10, and the second magnetic gap 4b is formed between the first magnetic pole 1b and the third magnetic pole 11. The first magnetic gap 4a and the second magnetic gap 4b are arranged so that the tracing of the magnetic flux in each of them forms the substantially “V” shape. The diaphragms 5a is arranged in the first magnetic gap 4a, and the diaphragm 5b is arranged in the second magnetic gap 4b. In addition, the diaphragms 5a and 5b are relatively positioned so that they are substantially in parallel with and opposite to each other and the shape formed by the combination of them has the substantially V-shaped cross-section. Thereby, the directional characteristic and the sound pressure characteristic in the high frequency band are structurally improved, and the acoustic wave in the extra high frequency band can be outputted in the wide range.

This point will be supplemented and explained below.

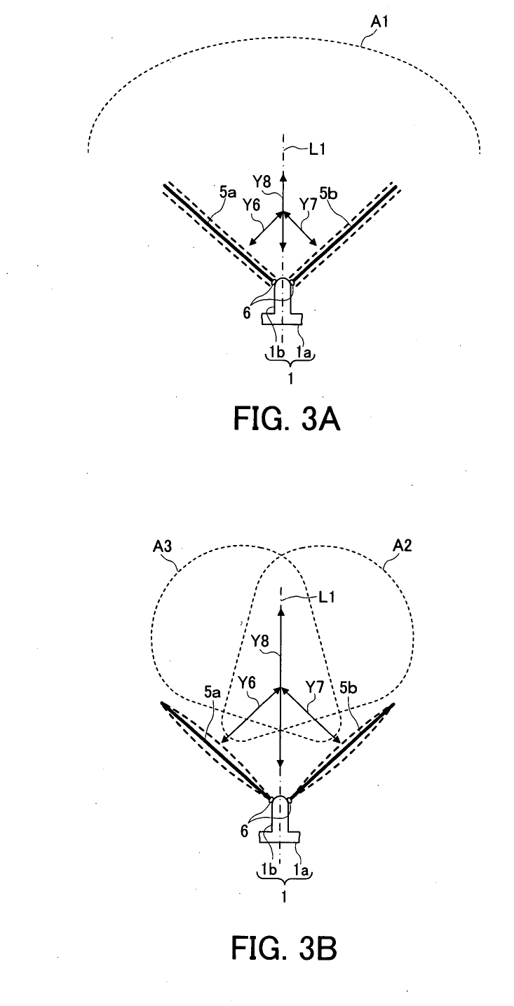

First, a description will be given of the operation of the diaphragms 5a and 5b in the low frequency band, with reference to FIGS. 3A and 3B. FIG. 3A is a cross-sectional view of an enlarged main part, in which the vicinity of the first magnetic pole 1b and the diaphragms 5a and 5b shown in FIG. 1B is enlarged, and it is an operation explanation view of the diaphragms 5a and 5b in the low frequency band. In FIG. 3A, broken lines shown above and below the diaphragms 5a and 5b show their positions after the movement.

In the low frequency band, before the divisional vibration of each of the diaphragms 5a and 5b starts, the diaphragm 5a vibrates in the direction of the arrow Y6 orthogonal with respect to the magnetic flux direction Y4 shown in FIG. 1B, and the diaphragm 5b vibrates in the direction of the arrow Y7 orthogonal with respect to the magnetic flux direction Y5 shown in FIG. 1B. However, since the diaphragms 5a and 5b are connected to the first magnetic pole 1b to have the substantially V-shaped cross-section, the vibration vectors in the directions of the arrows Y4 and Y6 of the diaphragm 5a and the vibration vectors in the directions of the arrows Y5 and Y7 of the diaphragm 5b are synthesized, and the diaphragms 5a and 5b vibrate in the direction of the arrow Y8 being the direction of the central axis L1 of the speaker device 100. Thereby, the large amount of synthesized acoustic waves of the diaphragms 5a and 5b is outputted in the direction of the arrow Y8 being the direction of the central axis L1 of the speaker device 100, as shown by a broken-line area A1.

Next, a description will be given of the operation of the diaphragms 5a and 5b in the high frequency band, with reference to FIG. 3B. FIG. 3B is a cross-sectional view of an enlarged main point, in which the vicinity of the first magnetic pole 1b and the diaphragms 5a and 5b shown in FIG. 1B is enlarged, and it is an operation explanation view of the diaphragms 5a and 5b in the high frequency band. In FIG. 3B, the broken lines shown above and below the diaphragms 5a and 5b show their positions after the movement.

In the high frequency band, the mechanical impedance of both the end parts of the diaphragms 5a and 5b are larger than those at the middle parts of the diaphragms 5a and 5b. Thus, though there is few vibrations in the vicinity of both the end parts, the vibration is large at the middle part. Therefore, in the vicinity of the middle part, the diaphragm 5a largely vibrates in the direction of the arrow Y6 orthogonal with respect to the magnetic flux direction Y4 shown in FIG. 1B, and the diaphragm 5b largely vibrates in the direction of the arrow Y7 orthogonal with respect to the magnetic flux direction Y5 shown in FIG. 1B. The acoustic wave generated by the vibration of the diaphragm 5a is outputted to have the directional characteristic shown in the broken-line area A2. The acoustic wave generated by the vibration of the diaphragm 5b is outputted to have the directional characteristic as shown in the broken-line area A3. In this manner, the vibration vectors of the diaphragms 5a and 5b are synthesized, and the large amount of synthesized acoustic waves are outputted in the direction of the arrow Y8 being the direction of the central axis L1 of the speaker device 100. Namely, in the extra high frequency band in which the wavelength is shorter than the length of the side of the V-shape of the diaphragms 5a and 5b, the large amount of acoustic waves are outputted in the vibration direction of the diaphragms 5a and 5b.

Therefore, the speaker device 100 according to this embodiment can structurally output the acoustic wave in the extra high frequency band in the wider range, as compared with the first and second comparative examples.

In addition, since the diaphragms 5a and 5b are arranged to have the substantially V-shaped cross-section, the strength of the diaphragms 5a and 5b in the direction of the central axis L1 of the speaker device 100 can be improved, as compared with the first and second comparative examples. Namely, the strength of the diaphragms 5a and 5b can be enhanced. Particularly, in the above-mentioned low frequency band, as shown in FIG. 3A, the diaphragms 5a and 5b after the movement maintain the initial shapes thereof and vibrate. Therefore, the strength of the diaphragms 5a and 5b can be further improved. In addition, in the case of the high frequency band, while the vibrations becomes small at both the end parts of the diaphragms 5a and 5b, the diaphragms 5a and 5b move so that the vibration becomes large at the middle part. Therefore, the deformation of the diaphragms 5a and 5b by the radiation impedance hardly occurs. Namely, in the case of the high sound pressure, it is prevented that the diaphragms 5a and 5b are deformed by the radiation impedance.

Additionally, in this embodiment, by varying the angle of the substantially V-shaped cross section of the diaphragms 5a and 5b, the directional characteristic in the high frequency band can be set to a desirable directional characteristic.

(Application-1)

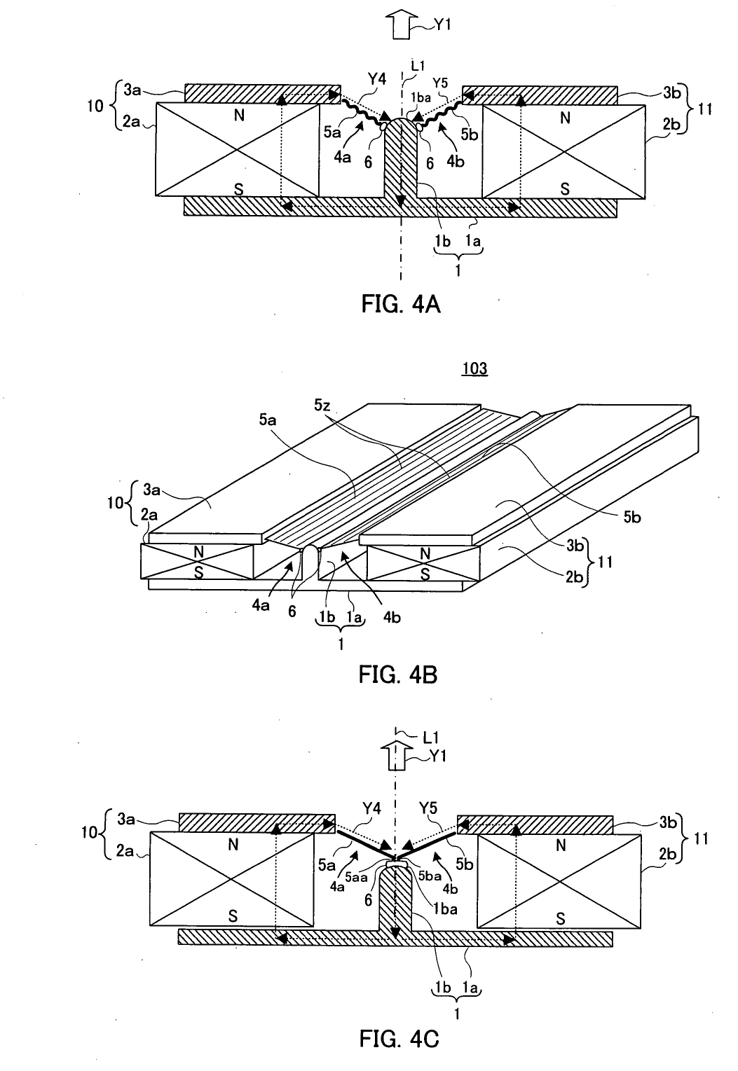

In the present invention, as an application-1, convexoconcave or corrugation shape may be formed on the entire diaphragms 5a and 5b, as shown in FIG. 4A. FIG. 4A shows a cross-sectional view of the speaker device according to the application-1 corresponding to FIG. 1B. Instead of this, in the present invention, the convexoconcave or corrugation shape may be formed not at the entire diaphragms 5a and 5b but at a part of them, which is not shown.

(Application-2)

Also, in the present invention, as an application-2, a muscle-like corrugation shape (muscle-like corrugation shaped part 5z) may be formed at the entire diaphragms 5a and 5b, as shown in FIG. 4B. FIG. 4B shows a perspective view of the speaker device according to the application-2 corresponding to FIG. 1A. Instead of this, in the present invention, the muscle-like corrugation shape (muscle-like corrugation shaped part 5z) may be also formed not at the entire diaphragms 5a and 5b but at the part of them, which is not shown.

(Application-3)

Additionally, in the present invention, as an application-3, one end 5aa of the diaphragm 5a, positioned on the side of the first magnetic pole 1b, and one end 5ba of the diaphragm 5b, positioned on the side of the first magnetic pole 1b, may be directly connected to each other via the viscoelastic material 6, and the one end 5aa and the one end 5ba may be further mounted on the upper end 1ba of the first magnetic pole 1b via the viscoelastic material 6, as shown in FIG. 4C. By this configuration, the low frequency sound can be more easily obtained, as compared with the above-mentioned embodiment. FIG. 4C shows a cross-sectional view of the speaker device according to the application-3 corresponding to FIG. 1B.

(Application-4)

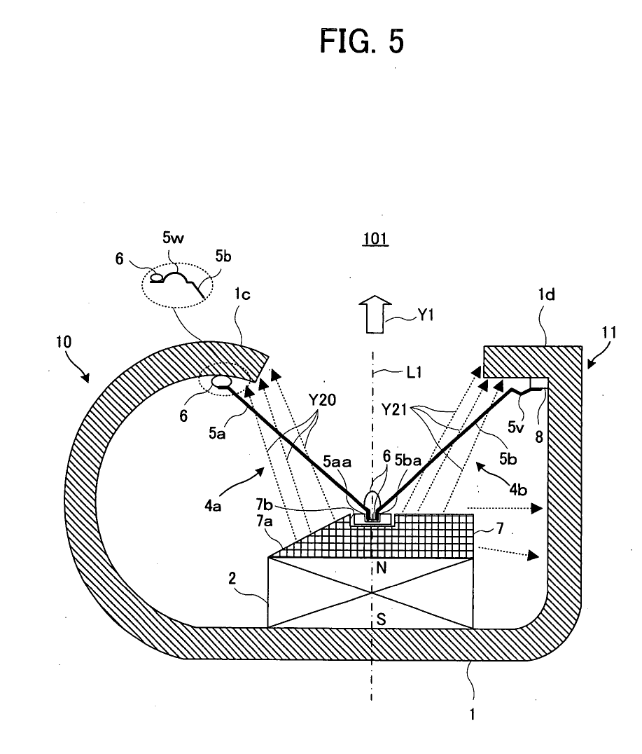

Next, a description will be given of a configuration of a speaker device 101 according to an application-4 of the present invention, with reference to FIG. 5. In the application-4, the same reference numerals are given to the same components as those of the above-mentioned embodiment, and explanations thereof are simplified or omitted. FIG. 5 shows the cross-sectional configuration of the speaker device 101 according to the application-4 of the present invention, corresponding to FIG. 1B.

The speaker device 101 includes the magnetic circuit including the yoke 1 having an opening on its upper surface and formed into a cylindrical shape, the magnet 2 arranged at the substantially central position of the yoke 1 and formed into a rectangular parallelepiped shape and the plate 7 having a trapezoid cross-section and formed into a rectangular parallelepiped shape, the diaphragms 5a and 5b and the driving part (corresponding to the driving part 70) (not shown).

The yoke 1 includes the second magnetic pole 10 having a curved cross-section and the third magnetic pole 11 having a hook-shaped cross-section. The end surface of the magnet 2, positioned on the side of the yoke 1, is magnetized to the S-pole, and the other surface of the magnet 2, positioned on the side of the plate 7, is magnetized to the N-pole, respectively. In the present invention, the positional relation may be reverse. The first pole includes the magnet 2 and the plate 7. A recessed part 7b and an inclined surface 7a are formed on the upper end surface of the plate 7. The first magnetic gap 4a is formed between the inclined surface 7a being the component of the first magnetic pole and the one end side 1c of the yoke 1 being the second magnetic pole 10. The second magnetic gap 4b is formed between the vicinity of the upper end surface of the plate 7 being the component of the first magnetic pole, positioned on the side opposite to the inclined surface 7a, and the other end side id of the yoke 1 being the third magnetic pole 11. The direction of the magnetic flux in the first magnetic gap 4a is set to the direction of the arrow Y20 from the inclined surface 7a of the plate 7 to the one end side 1c of the yoke 1, and the direction of the magnetic flux in the second magnetic gap 4b is set to the direction of the arrow Y21 from the upper end surface of the plate 7 to the other end side 1d of the yoke 1. Therefore, the shape formed by connecting the magnetic flux in the first magnetic gap 4a and the magnetic flux in the second magnetic gap 4b becomes the substantially “V” shape.

The one end side 5aa of the diaphragm 5a and the one end side 5ba of the diaphragm 5b are connected to each other by the viscoelastic material 6, and they are mounted onto the recessed part 7b of the yoke 1 via the viscoelastic material 6. The other end side of the diaphragm 5a is mounted on the one end side 1c of the yoke 1 via the viscoelastic material 6. An edge 5v having a V-shaped cross-section is provided on the other end side of the diaphragm 5b, and the one end side of the edge 5v is mounted on the other end side 1d of the yoke 1 via a gasket (a buffer material) 8. Thereby, the shape formed by combining the diaphragms 5a and 5b has the substantially V-shaped cross-section, and each of the diaphragms 5a and 5b inclines in the direction adjacent to each other. The speaker device 101 according to the application-4, having the above-mentioned configuration, outputs the acoustic wave in the direction of the arrow Y1 in the accordance with the same principle of the speaker device 100 according to the above embodiment, and it has the same operation and effect as those of the above embodiment.

Additionally, in the application-4, the second magnetic pole 10 is formed to have the curved cross-section. The inclined surface 7a is provided on the plate 7 being the component of the first magnetic pole, and the distance between the first magnetic pole and the second magnetic pole 10 is made away from each other. The magnetic flux is concentrated between the inclined surface 7a and the one end side 1c of the yoke 1 being the component of the second magnetic pole 10. Thereby, the leak of the magnetic flux can be reduced at the first magnetic gap 4a formed between the first magnetic pole and the one end side 1c of the yoke 1. That is, it can be prevented that the magnetic flux is weakened.

In the present invention, an edge 5w in a corrugation shape may be provided on the other end side of the diaphragm 5a positioned on the one end side 1c of the yoke 1. Further, the V-shaped edge 5v provided on the other end side of the diaphragm 5b may be replaced with the edge 5w in the corrugation shape, similarly.

(Application-5)

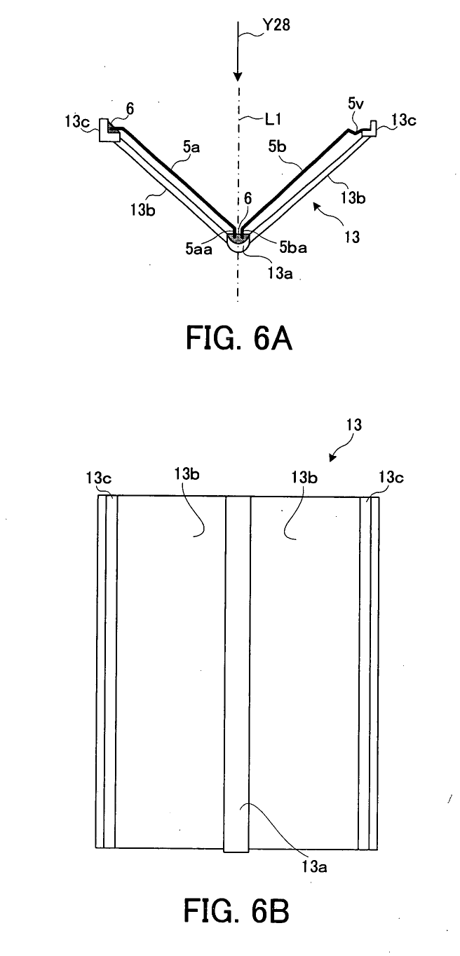

Additionally, in the present invention, as an application-5, a diaphragm mounting member 13 having a V-shaped cross-section may be provided, and the diaphragms 5a and 5b may be mounted thereon, as shown in FIG. 6A. FIG. 6A is a main part cross-sectional view showing such a state that the diaphragms 5a and 5b of the speaker device 101 shown in FIG. 6A are mounted on the diaphragm mounting member 13. FIG. 6B shows a plan view of the diaphragm mounting member 13 when observed from the direction of the arrow Y28 shown in FIG. 6A.

As shown in FIGS. 6A and 6B, the diaphragm mounting member 13 has the substantially V-shaped cross-section and the rectangle plane shape, and it supports the one end side 5aa of the diaphragm 5a and the one end side 5ba of the diaphragm 5b in a state of inserting them thereto. The diaphragm mounting member 13 includes a first supporting part 13a having a recessed shape, a second supporting part 13c for supporting the other end side of the diaphragm 5a and the edge 5v of the diaphragm 5b, and a third supporting part 13b provided between the first supporting part 13a and the second supporting part 13c and arranged in parallel with the diaphragms 5a and 5b, respectively. In a preferred example, the first supporting part 13a is preferably formed into such a shape that it can be slid to and mounted on the recessed part 7b of the plate 7 shown in FIG. 5 after assembling the magnetic circuit of the speaker device. Thereby, the manufacturing time of the speaker device can be shortened.

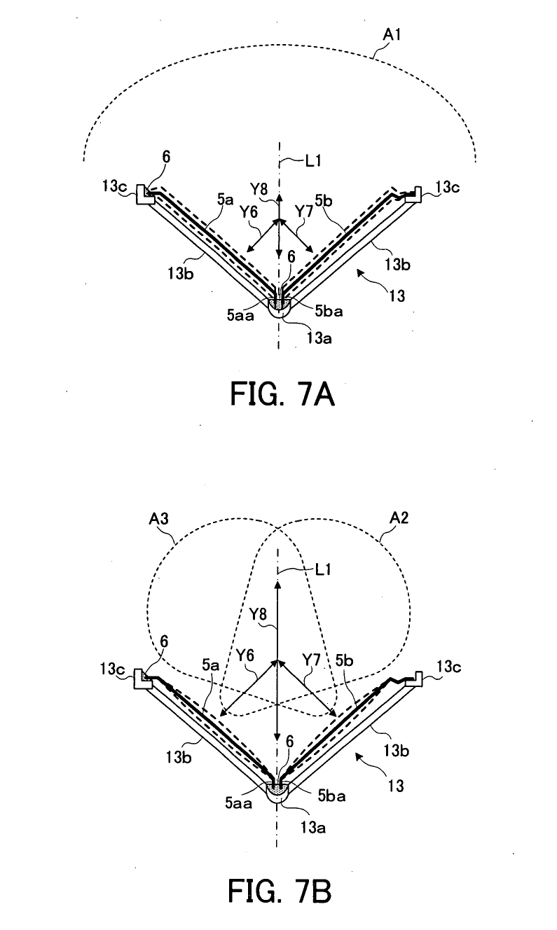

Next, the operation of the diaphragms 5a and 5b according to the application-5 will be explained with reference to FIGS. 7A and 7B. FIG. 7A is a cross-sectional view corresponding to the diaphragm mounting member 13 and the diaphragms 5a and 5b shown in FIG. 6A, and it is an operation explanation view of the diaphragms 5a and 5b in the low frequency band. FIG. 7B is a cross-sectional view corresponding to the diaphragm mounting member 13 and the diaphragms 5a and 5b shown in FIG. 6A, and it is an operation explanation view of the diaphragms 5a and 5b in the high frequency band. In FIGS. 7A and 7B, broken lines shown above and below the diaphragms 5a and 5b show positions after their movement.

The operation of the diaphragms 5a and 5b in the low frequency band and the high frequency band in the application-5 is same as that of the above-mentioned embodiment. However, in the application-5, the one end side 5aa of the diaphragm 5a and the one end side 5ba of the diaphragm 5b are mounted on the first supporting part 13 of the diaphragm mounting member 13 via the viscoelastic material 6 (or silicone), respectively. The other end sides of the diaphragms 5a and 5b are mounted on the second supporting part 13c of the diaphragm mounting member 13 via the viscoelastic material 6, respectively. Hence, the diaphragms 5a and 5b can be further stably vibrated in the low frequency band and the high frequency band, as compared with the above-mentioned embodiment.

(Application-6)

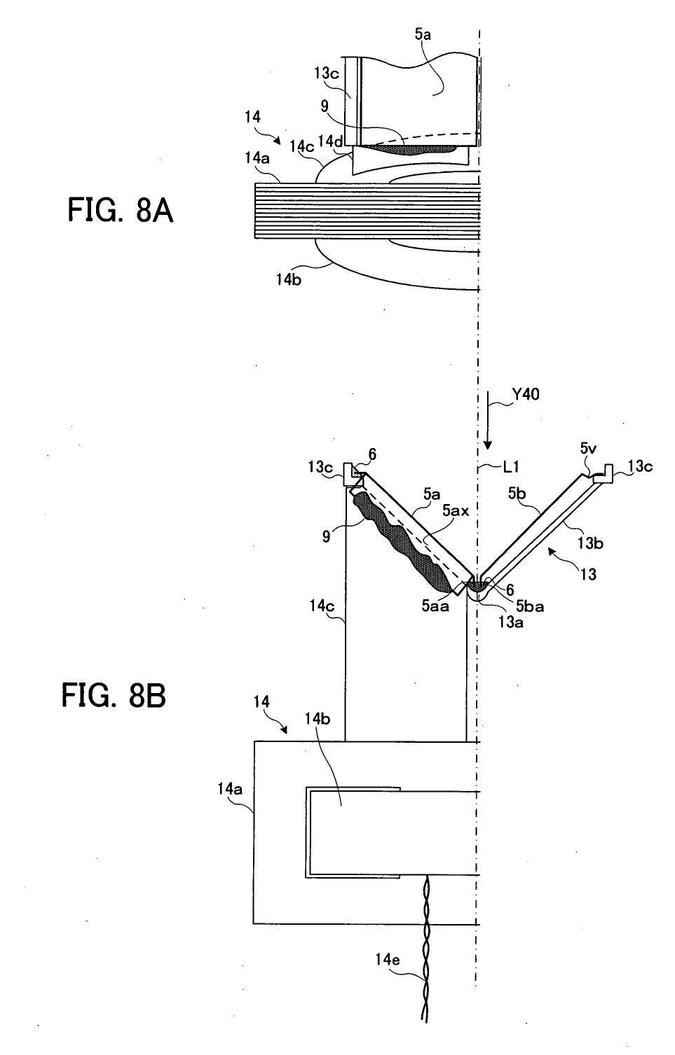

Additionally, in the present invention, as an application-6, the diaphragms 5a and 5b may be connected to the driving part (corresponding to the driving part 70) (not shown) via the impedance conversion transformer 14, as shown in FIGS. 8A and 8B. FIG. 8B is a main part side view showing a connection state between the diaphragms 5a and 5b and the impedance conversion transformer 14 shown in the application-5. FIG. 8A is a side main part plan view showing the connection state between the diaphragms 5a and 5b and the impedance conversion transformer 14 shown in the application-5 when observed from the direction of the arrow Y40 shown in FIG. 8B.

Namely, the diaphragms 5a and 5b according to the embodiment are the so-called ribbon-shaped diaphragms. Since the electrical impedance is extremely low, it is effective that the impedance is appropriately converted in a case of connecting the diaphragms 5a and 5b to the driving part. Therefore, in the application-6, by providing the impedance conversion transformer 14 having a function to appropriately convert the impedance, the diaphragms 5a and 5b are connected to a secondary transformer 14c of the impedance conversion transformer 14.

Concretely, the impedance conversion transformer 14, which is generally referred to as “matching transformer”, includes a transformer core 14a, a primary transformer 14b, the secondary transformer 14c, a copper plate 14d drawn from the secondary transformer 14c, and an input conductor 14e drawn from the primary transformer 14b and to which the driving current is supplied from the driving part (not shown). The one end of the diaphragm 5a, electrically connected to the impedance conversion transformer 14, is folded, and the fold part 5ax is electrically connected to the copper plate 14d via a solder 9 mainly made of aluminum. Thereby, the impedance conversion transformer 14 performs the impedance conversion of the driving current supplied from the driving part, and supplies the driving current to the diaphragms 5a and 5b. Thereby, it can be prevented that the conversion efficiency decreases particularly at the time of the high-frequency-band reproduction.

In addition, in the application-6, the diaphragms 5a and 5b are mounted on the diaphragm mounting member 13 to be electrically connected to the secondary transformer 14c of the impedance conversion transformer 14, at the time of the manufacture. Thereby, similarly to the above-mentioned application-5, the subsequent process can be simplified.

(Application-7)

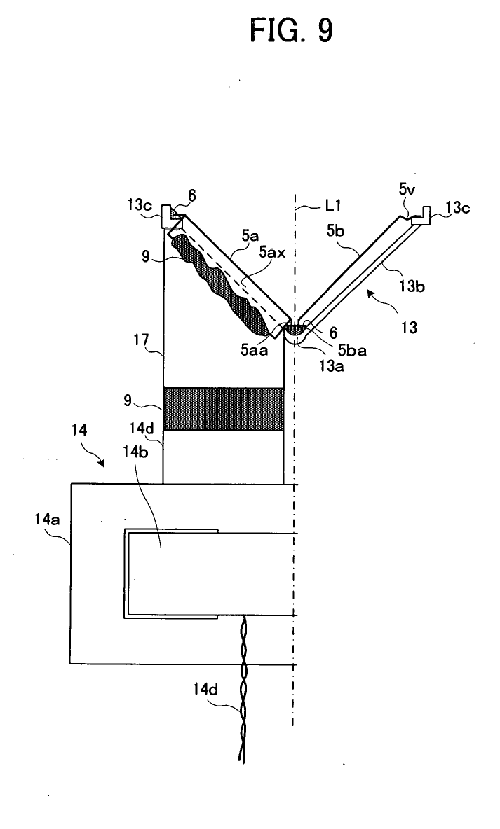

Additionally, in the present invention, an application-7 may be formed by slightly changing the configuration of the application-6, as shown in FIG. 9. FIG. 9 is a main part side view showing the connection state between the diaphragms 5a and 5b and the impedance conversion transformer 14 according to the application-7, corresponding to FIG. 8B.

Namely, in the application-7, the fold part 5ax of the diaphragm 5 is connected to a terminal board 17 made of a conductive material via the solder 9, and the terminal board 17 is connected to the copper plate 14d of the impedance conversion transformer 14 via the solder 9. Thereby, the same operation and effect as those of the application-6 can be obtained.

(Application-8)

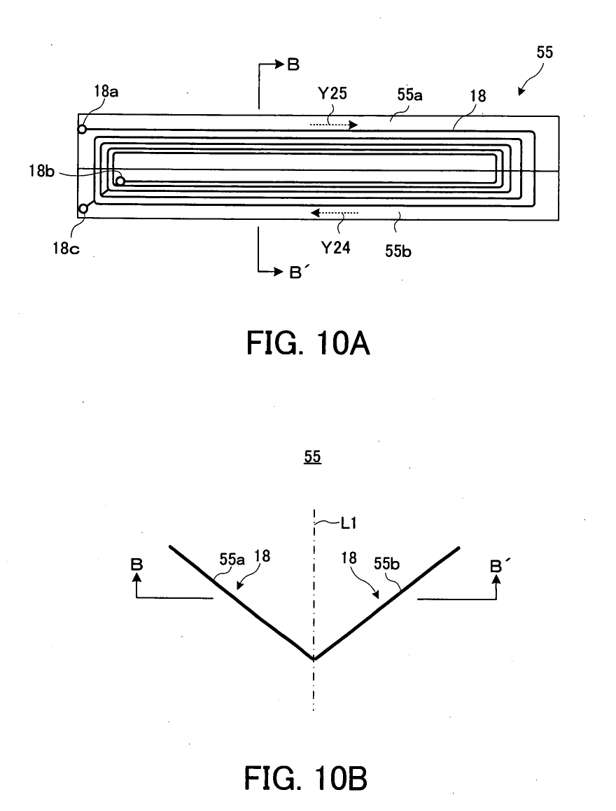

Additionally, in the present invention, as an application-8, the diaphragms 5a and 5b are not made of the conductive material having the conductive property such as the metallic foil, but made of a resin film and the wiring (conductive material) 18 formed on its surface, as shown in FIGS. 10A and 10B. FIG. 10A is a plan view showing a plane configuration of a diaphragm 55 according to the application-8. FIG. 10B shows a cross-sectional view of the diaphragm 55 taken alone a cutting line B-B′ shown in FIG. 10A.

The diaphragm 55, having a V-shaped cross-section, includes resin film bodies 55a and 55b having a ribbon shape and a short-rectangular shape, and the wiring (conductive material) 18 integrated with the resin film bodies 55a and 55b.

The wiring (conductive material) 18 has terminals 18a and 18b connected to the plus and minus wirings on the side of the driving part (corresponding to the driving part 70). The wiring 18 is integrally and spirally formed on a surface on the sound output side of the resin film bodies 55a and 55b. In addition, one end of the wiring 18 is connected to the terminal 18b at a predetermined position on the surface on the sound output side of the resin film body 55b, and a part of the wiring 18 extending from the terminal 18b is drawn to the surface opposite to the sound output side of the resin film body 55b to be connected to the terminal 18c formed on the opposite surface. Thereby, the driving current can be supplied to the wiring 18 from the driving part (not shown). In this configuration, since the wiring 18 is spirally formed on the surface on the sound output side of the diaphragm 55, the direction of the driving current flowing in the resin film body 55a and the direction of the driving current flowing in the resin film body 55b are relatively opposite. For example, if the driving current is assumed to flow in the wiring 18 formed on the resin film body 55a in the direction of the arrow Y25, the driving current flows in the wiring 18 formed on the resin film body 55b in the direction of the arrow Y24 opposite to the arrow Y25. Thereby, in accordance with Fleming's left-hand rule, the resin film bodies 55a and 55b can be made to vibrate in the same direction with the same amount of driving force. Thus, the operation and effect of the above-mentioned embodiment can be obtained.

(Application-9)

Additionally, in the present invention, as an application-9, the diaphragm may be formed by folding the conductive material made of a metallic foil in several times in order to have the substantially “V” shape formed by combining the diaphragms 5a and 5b of the above-mentioned embodiment.

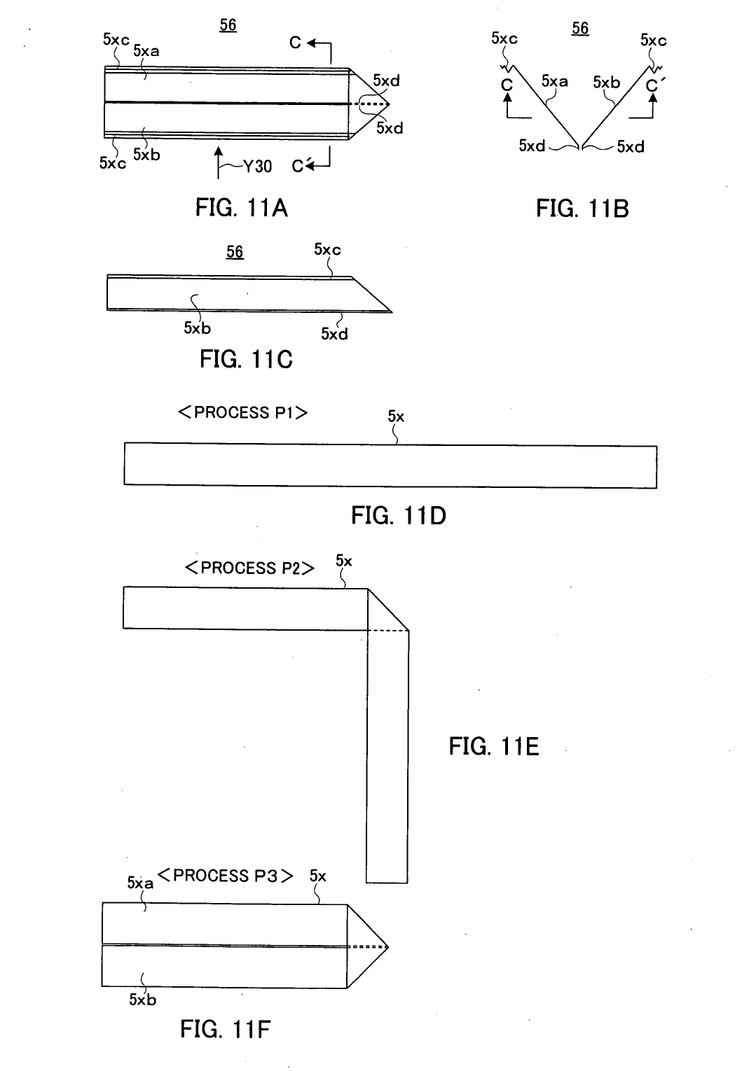

A configuration of a diaphragm 56 according to the application-9 is shown in FIGS. 11A to 11C. FIG. 11A shows a plane configuration of the diaphragm 56 when observed from the direction from which the acoustic wave is outputted. FIG. 11B shows a cross-sectional view of the diaphragm 56 taken along the cutting line C-C′ shown in FIG. 11A. FIG. 11C shows a side view of the diaphragm 56 when observed from the direction of the arrow Y30 shown in FIG. 11A.

The diaphragm 56 is formed by folding the conductive material made of the metallic foil in several times, and it has the substantially V-shaped cross-section. The diaphragm 56 includes sound output parts 5xa and 5xb, and an edge 5xc having a corrugation shape, formed on each of end sides of the sound output parts 5xa and 5xb. A fold part 5xd connected to the first magnetic pole 1ba shown in FIG. 1B is formed on each of other end sides of the sound output parts 5xa and 5xb.

The diaphragm 56 having the configuration is formed as follows.

First, as shown in FIG. 11D, a ribbon-shaped and short-rectangular conductive material 5x made of the metallic foil is prepared (process P1). Next, as shown in FIG. 11E, the substantially middle part of the conductive material 5x is folded in a substantially right angle (process P2). Subsequently, a part of the conductive material 5x to be the sound output part 5xb is folded in the substantially right angle so as to be in parallel with a part of the conductive material 5x to be the sound output part 5xa (process P3). Thereby, the sound output parts 5xa and 5xb are formed. Next, as shown in FIGS. 11A to 11C, the edge 5xc having the corrugation shape is formed on each of end sides of the sound output parts 5xa and 5xb, and a fold part 5xd connected to the first magnetic pole 1ba is formed on each of other end sides of the sound output parts 5xa and 5xb. Thereby, the diaphragm 56 according to the application-9 shown in FIGS. 11A to 11C is manufactured. Since the diaphragm 56 having the above-mentioned configuration has the substantially V-shaped cross-section, similarly to the above embodiment, the operation and effect of the above-mentioned embodiment can be obtained.

(Application-10)

Generally, in the speaker device for the high-frequency-band reproduction, a peak and a dip easily occur in the high frequency band. Thus, a phase equalizer (an equalizer or an acoustic wave diffuser of a magnetic substance or a restrictor to increase an acoustic wave load) is sometimes provided in front of the diaphragm in order to equalize the high-frequency-band characteristic and improve the directional characteristic.

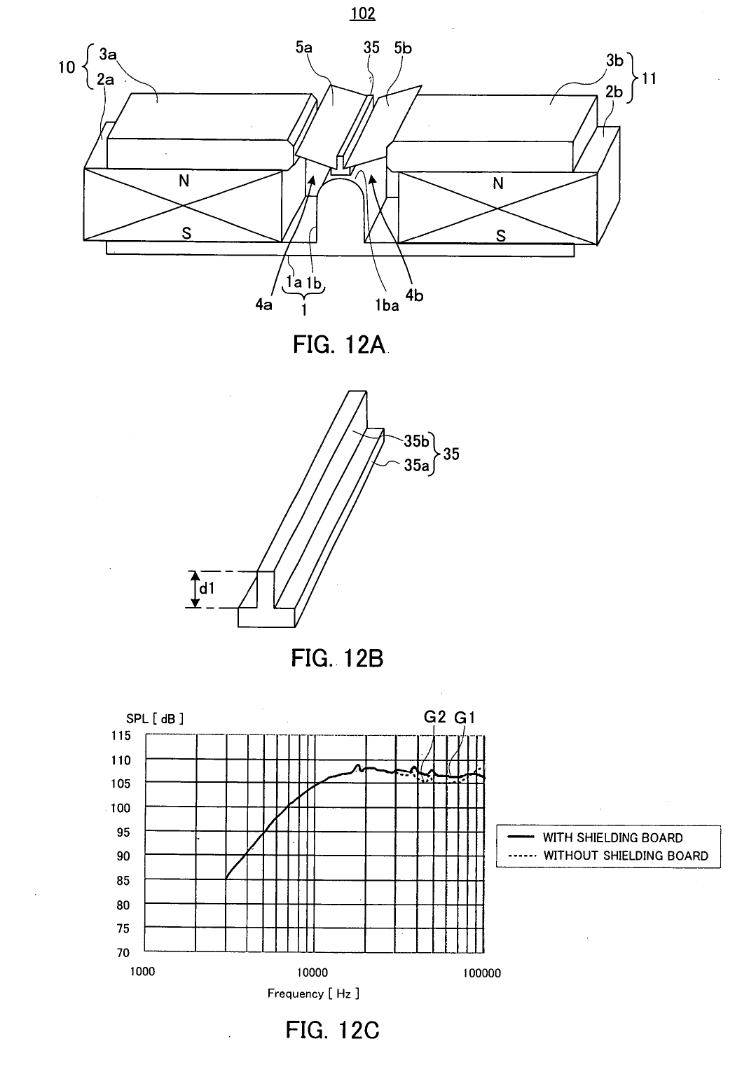

In the application-10 of the present invention, the phase equalizer is provided at a predetermined position of the speaker device based on the same configuration as that of the above embodiment, in order to realize the above-mentioned purpose. Now, the configuration will be explained with reference to FIGS. 12A and 12B. In the application-10, the same reference numerals are given to the same components as those of the speaker device 100 according to the above embodiment, and explanations thereof are simplified or omitted.

FIG. 12A shows a perspective view of the speaker device 102 according to the application-10 of the present invention, corresponding to FIG. 1B. FIG. 12B is a perspective view showing the configuration of a phase equalizer 35.

The configuration of the speaker device 102 according to the application-10 is basically same as the configuration of the speaker device 100 according to the above-mentioned embodiment. However, the speaker device 102 is structurally different from the speaker device 100 in that the speaker device 102 includes the phase equalizer. Additionally, the speaker devices 100 and 102 are slightly different in their sizes.

The phase equalizer 35, made of a material having an insulating property and having a cross-section and a side shape formed into a reversed “T” and projecting shape, includes a first part 35a having a rectangular parallelopiped shape, and a second part (projecting part) 35b upwardly projecting from the substantially middle position of the first part 35a. The second part 35b has a function to control the directional characteristic and the output sound pressure characteristic by appropriately varying its length, and a function to prevent the short circuit between the diaphragms 5a and 5b by insulating the diaphragms 5a and 5b having the conductive property from each other.

The phase equalizer 35 is provided in the speaker device 102 in such a state that the one end surface side of the first part 35 is mounted on the upper end 1ba of the first magnetic pole 1b. The one end side of the diaphragm 5a and the one end side of the diaphragm 5b is mounted on the upper surface of the first part 35a of the phase equalizer 35 in a manner sandwiching the second part 35b, respectively. Therefore, the second part 35b of the phase equalizer 35 projects in the upward direction being the sound output direction between the diaphragms 5a and 5b.

The speaker device 102 according to the application-10 having the above-mentioned configuration has characteristic operation and effect, as compared with the comparative example as described below.

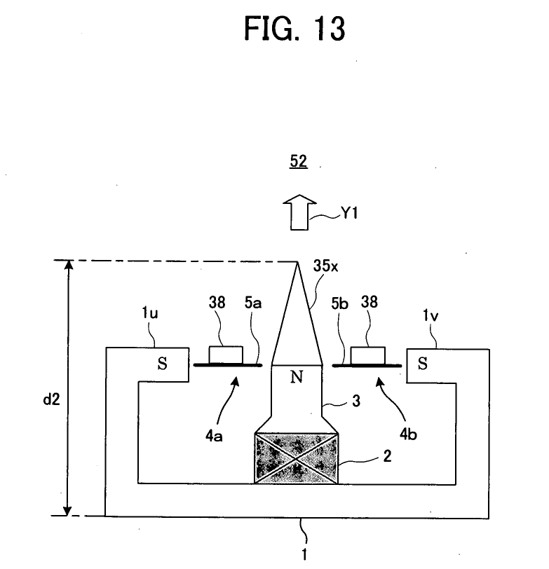

FIG. 13 shows a cross-sectional configuration of the speaker device according to the comparative example having the phase equalizer.

The speaker device 52 according to the comparative example is the so-called leaf-shaped speaker device. The speaker device 52 has an opening on its upper surface, the magnetic circuit including the cylindrical yoke 1, the magnet 2 arranged at the substantially central position of the yoke 1, the plate 3 arranged on the magnet 2, the diaphragms 5a and 5b including a wiring 38 to which the driving current is supplied from the driving part (not shown), and a phase equalizer 35x, arranged on the plate 3, having a triangle cross-section and having a function to control the directional characteristic and the output sound pressure characteristic.

In the comparative example having the configuration, since the phase equalizer 35x is high, the range of the controllable frequency advantageously becomes wide by the amount. However, the height d2 of the speaker device 52 corresponding to the sound output direction becomes high, and it is problematically difficult to meet the demand of the thin speaker device 52.

On the contrary, in the speaker device 102 according to the application-10, the phase equalizer 35 is provided on the first magnetic pole positioned below the second magnetic pole 10 and the third magnetic pole 11 to upwardly project between the two diaphragms 5a and 5b. Thus, even though the height dl of the second part 35b of the phase equalizer 35 is set to the same height as that of the comparative example, the thin speaker device 102 can be realized. Therefore, in the application-10, the projecting amount (height d1) of the second part 35b of the phase equalizer 35 can be small in accordance with the purpose, and the thin speaker device can be realized. Namely, the thin ribbon-shaped speaker device can be obtained. In addition, because of this configuration, the variable range of the height of the phase equalizer 35 can be large, and it becomes possible to perform the correction for the purpose of the desired sound pressure characteristic.

Additionally, since the phase equalizer 35 is made of the material having the insulating property and provided between the diaphragms 5a and 5b, the second part 35b of the phase equalizer 35 functions as a shielding board for shielding the diaphragms 5a and 5b from each other. Namely the second part 35b functions to insulate the diaphragms 5a and 5b having the conductive property. Thereby, it can be prevented that the short circuit between the diaphragms 5a and 5b occurs.

Moreover, since the speaker device 102 according to the application-10 includes the phase equalizer 35 functioning as the shielding board, the peak and the dip can be suppressed in the high frequency band, and the high-frequency-band signal can be equalized. As for this point, a description will be comparatively given of the characteristics of the sound pressure level [SPL(dB)] and the frequency (Hz) between the speaker device 102 according to the application-10 and the speaker device according to the other comparative example, with reference to FIG. 12C. It is prescribed that the speaker device according to the other comparative example, having the configuration similar to that of the speaker device 102, does not include the phase equalizer 35 functioning as the shielding board between the diaphragms 5a and 5b.

FIG. 12C is a graph showing a relation between the sound pressure and the frequency characteristic of the speaker device according to the other comparative example and the speaker device 102 according to the application-10. A graph G1 shown by a solid line shows the relation between the sound pressure and the frequency characteristic of the speaker device 102 according to the application-10. Meanwhile, a graph G2 shown by a broken line shows the relation between the sound pressure and the frequency characteristic of the other comparative example.

As shown in FIG. 12C, it is understood that, in the high frequency band equal to or larger than 10000 (Hz), the characteristic of the application-10 is equalized, as compared with that of the other comparative example. Hence, in the speaker device 102 according to the application-10, the high-frequency-band signal can be equalized, and the preferable sound pressure characteristic can be obtained in the high frequency band.

As other operation and effect, the operation and effect similar to those of the above embodiment can be obtained in the application-10.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2006-115355 filed on Apr. 19, 2006 including the specification, claims, drawings and summary is incorporated herein by reference in its entirety.

What is claimed is:

1. A speaker device comprising:
a magnetic circuit which has at least two magnetic gaps;
at least two diaphragms which have conductive properties and which are arranged substantially in parallel with and opposite to each other in each of the magnetic gaps; and
a driving part which supplies a driving current to each of the diaphragms,
wherein a direction of a magnetic flux in each of the magnetic gaps and a direction of the driving current supplied to each of the diaphragms are set such that each of the diaphragms moves in a same direction, and
wherein each of the diaphragms inclines in a direction adjacent to each other.

2. The speaker device according to claim 1,
wherein the magnetic circuit includes a first magnetic pole provided at a substantially middle position thereof, a second magnetic pole and a third magnetic pole provided on both sides of the first magnetic pole,
wherein the first magnetic pole is positioned below the second magnetic pole and the third magnetic pole,
wherein each of the magnetic gaps is formed between the first magnetic pole and the second magnetic pole and between the first magnetic pole and the third magnetic pole, and a direction of the magnetic flux in each of the magnetic gaps is relatively opposite, and
wherein each of the diaphragms is arranged along the direction of the magnetic flux in each of the magnetic gaps.

3. The speaker device according to claim 1,
wherein the direction of the magnetic flux in each of the magnetic gaps is relatively opposite, and
wherein the direction of the driving current is relatively opposite in each of the diaphragms.

4. The speaker device according to claim 1,
wherein, when the magnetic circuit and each of the diaphragms are observed from a direction substantially orthogonal with respect to the direction of the driving current, a shape formed by connecting the magnetic flux between the first magnetic pole and the second magnetic pole and the magnetic flux between the first magnetic pole and the third magnetic pole is a substantially V shape, and a shape formed by connecting each of the diaphragms is a substantially V shape.

5. The speaker device according to claim 4,
wherein the first magnetic pole is formed by a part of a yoke, and each of the second magnetic pole and the third magnetic pole is formed by a combination of a magnet and a plate, respectively, and
wherein an upper end of the part of the yoke is positioned below an upper end of the plate.

6. The speaker device according to claim 1, wherein each of the diaphragms has a ribbon and short rectangular shape, and the magnetic circuit has a rectangular parallelepiped shape.

7. The speaker device according to claim 1, wherein each of the diaphragms is made of a metallic foil.

8. The speaker device according to claim 1, wherein each of the diaphragms is made of a resin film and a conductive material formed on a surface of the resin film and to which the driving current is supplied.

9. The speaker device according to claim 1, wherein each of the diaphragms is formed by folding a metallic foil having a ribbon and short rectangular shape.

10. The speaker device according to claim 2, wherein one end side of each of the diaphragms positioned on a side of the first magnetic pole is connected to each other by a viscoelastic material.

11. The speaker device according to claim 2, wherein one end side of each of the diaphragms positioned on a side of the first magnetic pole is mounted on the first magnetic pole via a viscoelastic material.

12. The speaker device according to claim 2, wherein another end side of each of the diaphragms positioned on a side opposite to the first magnetic pole has a corrugated cross-section.

13. The speaker device according to claim 1, wherein an entire or a part of each of the diaphragms has a corrugation or convexoconcave shape.

14. The speaker device according to claim 1, wherein each of the diaphragms is mounted on the first magnetic pole via a diaphragm mounting member for supporting each of the diaphragms.

15. The speaker device according to claim 2, wherein a phase equalizer having a function to equalize high-frequency-band signal is provided between the diaphragms positioned on a side of the first magnetic pole and on the first magnetic pole.

16. The speaker device according to claim 15,
wherein the phase equalizer has an insulating property and includes a projecting part formed into a projecting shape and upwardly projecting between the diaphragms positioned on the side of the first magnetic pole, and
wherein each of the diaphragms is mutually shielded by the projecting part.
